(19) United States
(12) Patent Application Publication
(10) Pub. No.: US 2011/0133126 A1
(43) Pub. Date: Jun. 9, 2011

(54) VERTICAL CYLINDRICAL REACTOR WITH THIN CATALYST BED

(75) Inventor: Dennis Lippmann, Dortmund (DE)

(73) Assignee: UHDE GMBH, Dortmund (DE)

(21) Appl. No.: 13/058,746

(22) PCT Filed: Aug. 10, 2009
(86) PCT No.: PCT/EP09/05792

§ 371 Date: Feb. 15, 2011

(30) Foreign Application Priority Data
Aug. 11, 2008 (DE) 10 2008 037 215.3
Aug. 11, 2008 (DE) 10 2008 037 216.1

(51) Int. Cl. C01B 3/02; B01J 8/02

(52) U.S. Cl. 252/373; 422/211

(57) ABSTRACT

An axial thin-film reactor for carrying out catalytic reactions in the gas phase, comprising a cylindrical pressure casing, a device for letting in a gaseous reactant stream, a device for letting out a gaseous product stream, a device for receiving a catalyst bed arranged vertically in the reaction chamber and isolated from the reactor wall at the sides and at the ends so as to produce two separate chambers for the gaseous reactant stream and the gaseous product stream that are sealed with respect to one another and have two gas-permeable bounding walls arranged plane-parallel to one another. The device is designed in such a way that it has a height-to-thickness ratio greater than 1 and the catalyst bed has a height-to-thickness ratio greater than 1.

The invention relates to a vertically arranged cylindrical reactor provided with a thin catalyst bed layer through which gas is passed in horizontal direction and which is referred to hereinafter as a thin-layer reactor. The special feature of the reactor configuration according to the invention is that the vertically arranged device for holding the catalyst bed comprises two confining walls which run plane-parallel to each other and are permeable to gas, the device vertically arranged in the reaction chamber for holding the catalyst bed is of a height-to-thickness ratio larger than 1, the catalyst bed is of a height-to-thickness ratio larger than 1, the catalyst bed extending over its full height along the vertical reactor axis, and that the gas inlet and the gas outlet of the catalyst bed are arranged at an angle to the reactor axis, whereas gas inlet and gas outlet of the reactor are provided at the same height of the cylindrical pressure shell.

Potential applications of such a reactor for the performance of catalytic reactions in the gas phase are, for example, the CO conversion or methanation in the production of syngas.

In the case of standard-type reactors, heterogeneous catalytic reactions are carried out in axial catalyst beds, wherein a catalyst bed of a height-to-diameter ratio of typically >1 is integrated into a cylindrical reactor, the flow usually being vertical from top to bottom in direction of the reactor axis. This type of reactor configuration is characterised by a simple design as the number of internals can be reduced to a minimum.

The design, however, involves a relatively high pressure drop while the gas is passing through. A reduction of the thickness of the layer passed by gas or of the height-to-diameter ratio in order to lower the pressure drop is possible only if the reactor diameter is enlarged, which will increase the cost of the reactor because a larger wall thickness will be required.

The above-mentioned problem could be optimised by designing the reactors with hemispherical heads and loading catalyst also in part of the volume of the hemispherical heads. It is still necessary, however, to dimension reactors of such design with a large diameter in order to keep the pressure drop in industrial-scale plants as little as possible.

Document CA 1248327 A1 describes a horizontal reactor for the production of ammonia. The disadvantage of the design apart from the large space required is, however, that the device for holding the catalyst bed is to bear the complete weight force of the catalyst to allow for a gas outlet at the bottom. Furthermore, the complete built-in assembly must be pulled out in horizontal direction if the catalyst is to be exchanged.

According to the state of the art, the lowest pressure drop occurs in the case of reactors with catalyst beds in radial design. A description of such reactor can be found in U.S. Pat. No. 4,181,701, for example. A great disadvantage of this design, however, is the high fabrication and installation expenditure incurred by the necessary internals.

Patent application DE 3026199 A1 which is open to public inspection describes a reactor the catalyst material of which is provided in layers arranged one on top of the other, the passage being predominantly in radial direction, thus being characterised by an improved utilisation of the catalyst volume and apart from this by a simplified internal design.

U.S. Pat. No. 2,112,335 claims a cylindrical horizontally arranged reactor which hence requires large floor space. The use of plane-parallel gas penetration surfaces is completely avoided in order to homogenise the flow impeded by liquid impurities moving downwards in the catalyst bed. The flow direction is axial along the reactor axis, which is the reason for the above-mentioned disadvantage of the high pressure drop as in the case of vertically arranged axial reactors. The only means to reduce the pressure drop is to enlarge the reactor diameter, which is very costly.

U.S. Pat. No. 4,246,235 describes a cylindrical gas-phase reactor which houses the catalyst bed in its middle section between two walls permeable to gas and vertically to the reactor axis. On top of this, further catalyst is provided for compensation purposes, this compensation volume being without any passage of flow and subdivided by a baffle. This baffle makes it necessary to provide two manholes for reloading catalyst material. Here again the flow direction is axial along the reactor axis, which is the reason for the above-mentioned disadvantages of the high pressure drop. The only means to reduce the pressure drop is to enlarge the reactor diameter, which is very costly.

The aim of the invention is to avoid the disadvantages of the specifically high pressure drop of a reactor with axial flow and in designing a reactor so to simplify and minimise the interior equipment in comparison to a radial reactor thus saving high fabrication expenditure and investment cost. This is to be done in a way that involves easy loading and emptying operations as regards the catalyst bed but also relieving the load on the device for holding the catalyst material in order to prevent the material from heavy loads. In addition, the aim of the invention is to disclose the process for running such reactor.

This is achieved by using an axial thin-layer reactor for performing catalytic reactions in the gas phase, consisting of a cylindrical pressure shell, a device for the inlet of a gaseous feed stream, a device for the outlet of a gaseous product stream and a device arranged vertically in the reaction chamber for holding a catalyst bed. The vertically arranged device for holding the catalyst bed is separated from the reactor wall on both sides and at the ends so that two separate compartments for the gaseous feed stream and the gaseous product stream are formed, which are sealed against each other. In addition, the vertically arranged device for holding the catalyst bed comprises two confining walls which run plane-parallel to each other and are permeable to gas and is designed such that the vertically arranged device for holding the catalyst bed is of a height-to-thickness ratio larger than 1 and the catalyst bed itself is of a height-to-thickness ratio larger than 1, the catalyst bed extending over its full height along the vertical reactor axis, and gas inlet and outlet of the catalyst bed being arranged at an angle to the reactor axis, whereas gas inlet and gas outlet of the reactor are provided at the same height of the cylindrical pressure shell. Reactor axis refers to the longitudinal axis of the cylindrical reactor.

As regards the flow configuration in the gas inlet and the gas outlet compartment, Bernoulli's equation is to be considered, which states that an increase in the velocity of a flowing fluid is associated with a decrease in the static pressure. By providing the gas inlet and the gas outlet deliberately at the same height of the cylindrical pressure shell it is achieved to maintain the same ratio of the gas velocity and thus also the static pressure across the height of the catalyst bed in both the gas inlet and the gas outlet compartment. In this way, the driving force of the pressure gradient across the height of the catalyst bed remains constant, thus achieving a uniform flow distribution through the catalyst. This makes it possible to do without costly internals such as devices equipped with different aperture areas for the passage of gas, which equalise the differences in the decrease of the static pressure across the height and thus ensure a uniform flow distribution through the catalyst material across the overall height of the reactor, or baffles. This will reduce the construction cost and/or improve the utilisation of the interior space and thus result in a specifically more cost-efficient reactor.

In the case of the embodiment according to the invention and in contrast to many radial reactor designs, the weight force of the catalyst material is not to be carried completely by the device for holding the catalyst material, thus minimising high loads on the material of the device for holding the catalyst material.

The vertical design of the axial thin-layer reactor according to the invention additionally allows a constructively simple transfer of the weight forces of the catalyst via the shell into the skirt as compared to horizontally arranged reactors which are only supported at the end points.

The axial thin-layer reactor according to the invention can be designed such that the device for holding the catalyst bed is composed of a plurality of vertically arranged devices for holding catalyst beds.

In another embodiment of the reactor the device for holding the catalyst bed is provided with a compensation volume filled with catalyst material to compensate for the shrinkage of the catalyst during operation, reduction or activation and thus prevent the formation of a gas bypass at the upper end of the catalyst bed. In a further embodiment of the reactor, this compensation volume is not sealed against the upper gas inlet or gas outlet compartment so that the compensation volume is also partly passed by gas in vertical direction and may thus also be used for reaction purposes.

Optionally, the axial thin-layer reactor is equipped with a manhole for loading the catalyst bed and/or a device for emptying the catalyst bed.

The process for performing catalytic reactions in a corresponding axial thin-layer reactor is characterised by a predominantly horizontal passage of the gaseous feed stream through the vertically arranged catalyst bed. Passage through the compensation volume in the upper part of the catalyst bed is also possible provided the catalyst bed is kept open towards the top and towards the gas inlet or gas outlet compartment. Otherwise there will be no passage through the compensation volume in the upper part of the catalyst bed, which is prevented by a device sealing the gas inlet compartment as well as the gas outlet compartment.

The invention is illustrated in greater detail in an exemplary fashion by means of three figures:

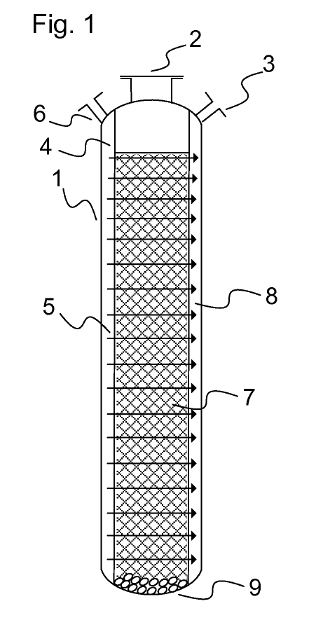

FIG. 1: Longitudinal section of an axial thin-layer reactor according to the invention with a vertically arranged device for holding a catalyst bed, the gas inlet and the gas outlet of which are arranged at the same height at the upper end of the cylindrical pressure shell.

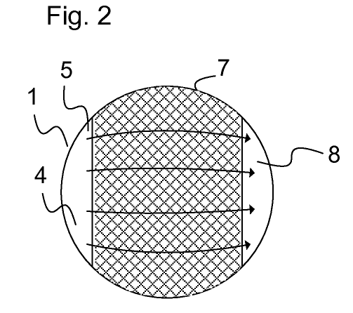

FIG. 2: Cross-section of an axial thin-layer reactor according to the invention with vertically arranged catalyst bed.

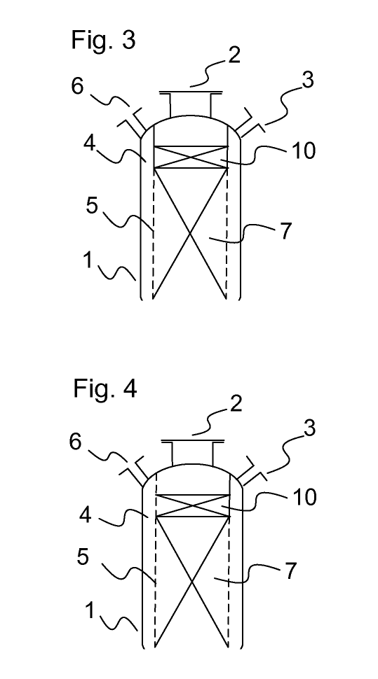

FIG. 3: Longitudinal section of the upper part of an axial thin-layer reactor according to the invention with a vertically arranged device for holding a catalyst bed, the gas inlet and the gas outlet of which are arranged at the same height at the upper end of the cylindrical pressure shell and which is provided with a compensation volume that is not passed by gas.

FIG. 4: Longitudinal section of the upper part of an axial thin-layer reactor according to the invention with a vertically arranged device for holding a catalyst bed, the gas inlet and the gas outlet of which are arranged at the same height at the upper end of the cylindrical pressure shell and which is provided with a compensation volume that is passed by gas.

FIG. 1 shows a reactor with a cylindrical pressure shell 1, having an opening 6 for the inlet of the feed stream at the upper end of the pressure shell and another opening 3 for the outlet of the product stream, which is also provided at the upper end of the pressure shell at the same height as the inlet of the feed stream. In the interior of the respective reactor there is a device 5 for holding a catalyst bed, which, in this example, is made of a perforated plate and delimits the catalyst filling towards the gas inlet and the gas outlet compartment. The bottom part of this device for holding the catalyst material, which is not passed by gas, can optionally be filled with inert material 9 to save catalyst. In both cases, the weight force of the catalyst material is directly transferred into cylindrical pressure shell 1. At the upper end of the respective reactor there is optionally a manhole 2 used for entry and installation of the internals as well as for loading the catalyst material should the access provided by the gas inlet nozzle be inadequate. While catalyst material is being filled in, catalyst bed 7 is formed. The introduced feed gas flows into feed gas compartment 4 in the interior of the reactor and can enter the catalyst bed via the apertures of perforated plate 5 and pass through the latter in horizontal direction and flow through perforated plate 5, which is on the opposite side of the catalyst bed and delimits the catalyst bed there, into product gas compartment 8 in the interior of the reactor. After the product stream has passed through catalyst bed 7, it can be discharged from the reactor via an outlet device 3.

FIG. 2 shows a cross-section of the axial thin-layer reactor represented in FIG. 1, in which feed stream 4 flows horizontally through catalyst bed 7, which is embedded into a device 5 for holding the catalyst bed, and is directed into product gas compartment 8.

FIG. 3 shows another advantageous embodiment of the invention. It differs from the embodiment shown in FIG. 1 in that a compensation volume 10 filled with catalyst material is provided at the upper end of catalyst bed 7. This compensation volume may be required to prevent that a gas bypass is formed when the catalyst material shrinks during operation or activation of the catalyst. In this embodiment, no gas passes through the compensation volume, which does not participate in the reaction of feed gas to product gas until it has sunk into that part of catalyst bed 7 which is passed by gas.

FIG. 4 differs from FIG. 3 exclusively in that compensation volume 10 is passed by gas and takes part in the reaction of a conversion of feed gas into product from the very beginning.

All exemplary embodiments may be provided with a plurality of openings for the inlet of the feed stream and the outlet of the product stream if, for instance, various gases are supplied to the reactor via separate feed lines.

Advantages resulting from the invention:
Owing to the thin and tall design it is possible to choose a cost-effective design for the cylindrical reactor pressure shell.
The small pressure drop across the thin axial layer helps to save operating cost.
The design of the device for holding the catalyst is less expensive than a radial bed.
The thin and tall design requires little floor space and can therefore also be integrated into already existing plants or used for re-equipment.
Baffles or various perforated plates for homogenising the static pressure difference across the height are no longer required, which largely simplifies the constructional requirements.
The absence of gas flow baffles ensures an efficient utilisation of the space in the cylindrical part, by which a higher product yield may be expected.
The device for holding the catalyst is not to bear the total catalyst weight and is thus relieved, since the weight force of the catalyst is transferred into the pressure shell directly or via inert material.
Catalyst loading and emptying is very simple if the manhole is arranged on the reactor axis.

### LIST OF REFERENCES USED

1 Cylindrical pressure shell of the reactor
2 Manhole
3 Opening at the upper end for the outlet of the product stream
4 Feed gas compartment
5 Device for holding a catalyst bed
6 Opening at the upper end for the inlet of the feed stream
7 Catalyst bed
8 Product gas compartment
9 Inert material
10 Compensation volume filled with catalyst material

1. Axial thin-layer reactor for the performance of catalytic reactions in the gas phase, comprising:
a cylindrical pressure shell,
a device for the inlet of a gaseous feed stream,
a device for the outlet of a gaseous product stream,
device vertically arranged in the reaction chamber for holding a catalyst bed, separated from the reactor wall on the sides and at the ends so that two separate compartments for the gaseous feed stream and the gaseous product stream are formed, which are sealed against each other,
characterised in that
the vertically arranged device for holding the catalyst bed is provided with two confining walls plane-parallel to each other and permeable to gas,
the device vertically arranged in the reaction chamber for holding the catalyst bed is of a height-to-thickness ratio larger than 1,
the catalyst bed is of a height-to-thickness ratio larger than 1, the catalyst bed extending over its full height along the vertical reactor axis,
the gas inlet and the gas outlet of the catalyst bed are arranged at an angle to the reactor axis, and
the gas inlet and the gas outlet of the reactor are provided at the same height of the cylindrical pressure shell.

2. Axial thin-layer reactor according to claim 1, characterised in that the device for holding the catalyst bed is composed of a plurality of vertically arranged devices for holding catalyst beds.

3. Axial thin-layer reactor according to claim 1, characterised in that a compensation volume is provided.

4. Axial thin-layer reactor according to claim 1, characterised in that the compensation volume is sealed towards all sides.

5. Axial thin-layer reactor according to claim 1, characterised in that the compensation volume is open towards the gas inlet side or the gas outlet side.

6. Axial thin-layer reactor according to claim 1, characterised in that a manhole and/or an emptying device are provided.

7. Process for performing catalytic reactions in an axial thin-layer reactor according to claim 1, characterised in that the passage of the gaseous feed stream through the catalyst bed is predominantly in horizontal direction.

8.-9. (canceled)

10. Process for performing catalytic reactions according to claim 7 in an axial thin-layer reactor characterised in that:
the compensation volume is sealed towards all sides, and
there is no passage of gaseous feed stream through the compensation volume in the upper part of the catalyst bed.

11. Process for performing catalytic reactions according to claim 7 in an axial thin-layer reactor characterised in that:
the compensation volume is open towards the gas inlet side or the gas outlet side, and
there is a passage of gaseous feed stream through the compensation volume in the upper part of the catalyst bed.
